(19) United States
(12) Patent Application Publication
(10) Pub. No.: US 2016/0085683 A1
(43) Pub. Date: Mar. 24, 2016

(54) DATA RECEIVING DEVICE AND DATA RECEIVING METHOD

(71) Applicant: KABUSHIKI KAISHA TOSHIBA, Tokyo (JP)

(72) Inventors: Hiroshi NISHIMOTO, Yokohama (JP); Takeshi ISHIHARA, Yokohama (JP)

(21) Appl. No.: 14/855,938

(22) Filed: Sep. 16, 2015

(30) Foreign Application Priority Data
Sep. 18, 2014 (JP) 2014-190420

(51) Int. Cl. G06F 12/08; G06F 3/06

(52) U.S. Cl. CPC G06F 12/0895; G06F 3/0604; G06F 3/0613; G06F 3/0631; G06F 3/067; G06F 2212/154; G06F 2212/604

(57) ABSTRACT

According to one embodiment, a data receiving device includes: a communication circuit to receive first data and second data over a network; a first storage; a second storage in which data read or data write is performed by a fixed size block; and a processor. The processor sets a first buffer and a second buffer in the first storage. The processor writes tail data of the first data into the allocated area in the second buffer. The tail data has a size of a remainder that a first value is divided by a size of the first buffer, the first value being a value subtracted from a size of the first data by a size of the available area in the first buffer before writing of the first data. The processor writes the second data into an area sequential to the area of the tail data.

### CROSS-REFERENCE TO RELATED APPLICATIONS

This application is based upon and claims the benefit of priority from Japanese Patent Application No. 2014-190420, filed Sep. 18, 2014; the entire contents of which are incorporated herein by reference.

### FIELD

Embodiments described herein relate to a data receiving device and a data receiving method.

### BACKGROUND

The development of communication technologies has improved the transmission rates in communication interfaces. However, instabilities in communication channels have not been resolved yet. In order to achieve stable end-to-end communications, processes such as acknowledgement on arrival and retransmission are essential. In addition, the use of communication channels having both wide bandwidths and long delays, such as wireless communications are becoming more common. In such communication channels, a transmitter device transmits a large amount of data to a receiver device over a network before receiving arrival confirmation from the receiver device to enhance an end-to-end communication rate.

However, in order to transmit a large amount of data through the network, a device is required to have an ability to process a lot of data at high speed. Thus, it is required not only to improve the speed of the communication channel, but also to improve the data processing speed and the data buffering and storing speed.

A known example that improves data buffering or data storing speed is a decision method that decides whether or not to flush the buffer depending on the data that is already written in the buffer; If the data can be appended it simply writes the data after the written area, and if the data cannot be appended it flushes the buffer before writing the data into the buffer. In addition, there is a known high speed printer in which, an arbitrary length buffer is allocated when the data is received using an HTTP connection; the data is temporarily saved in the buffer, in order to parallelize printing processes and receiving processes.

However, these prior arts involve a problem in that downloading data items concurrently using a plurality of connections may result in poor performance and moreover requires a large amount of memory. For example, consider a case of concurrently downloading data items using two connections, a connection 1 and a connection 2. In the first described prior art, alternately receiving two different data items causes a buffer to be flushed every time, resulting in very poor efficiency.

In contrast, in the second described prior art, a large sized buffer is needed depending on the number of connections that is used, which is a problem when using a device with a small memory capacity installed.

### BRIEF DESCRIPTION OF THE DRAWINGS

FIG. 1 is a functional block diagram of a data receiving device in a first embodiment;

FIG. 2 is a schematic diagram of a communication network system including the data receiving device;

FIG. 3 is a diagram showing the sequence of a process in which the data receiving device acquires a web page from a server device;

FIG. 4A is an explanatory diagram of a process of storing data in buffer;

FIG. 4B is an explanatory diagram of the process of storing data in buffer;

FIG. 4C is an explanatory diagram of the process of storing data in buffer;

FIG. 4D is an explanatory diagram of the process of storing data in buffer;

FIG. 4E is an explanatory diagram of the process of storing data in buffer;

FIG. 4F is an explanatory diagram of the process of storing data in buffer;

FIG. 4G is an explanatory diagram of the process of storing data in buffer;

FIG. 5 is a diagram showing an example of buffer management information;

FIG. 6 is a diagram showing a writing state of a storage when a receiving process for the response 1 and response 2 is completed;

FIG. 7 is a flow chart showing a basic flow of a process by the data receiving device in FIG. 1;

FIGS. 8(A) to 8(C) are detailed flow charts of some steps in the flow chart in FIG. 7;

FIG. 9 is a block diagram of a data receiving device in a second embodiment, which includes a module and a main processor;

FIG. 10 is a sequence diagram of an operation in the second embodiment;

FIG. 11 is a sequence diagram of another operation in a third embodiment;

FIG. 12 is a diagram showing an example of buffer management information in a fourth embodiment;

FIG. 13 is a diagram showing an example of storage management information in the fourth embodiment; and

FIG. 14 is a flow chart of an operation in the fourth embodiment.

### DETAILED DESCRIPTION

According to one embodiment, a data receiving device includes: a communication circuit to receive first data and second data over a network; a first storage in which data read or data write is performed; a second storage in which data read or data write is performed by a fixed size block; and a processor.

The processor comprises a setter and a specifier, wherein the setter sets a buffer of a size of an integral multiple of the block size in the first storage, and the specifier specifies a size of the first data received at the communication circuit.

The processor writes the first data received at the communication unit into an available area in a first buffer preset in the first storage.

The processor sets a second buffer in the first storage and allocates an area in the second buffer, the area having a size of a remainder that a first value is divided by a size of the first buffer, the first value being a value subtracted from a size of the first data by a size of the available area in the first buffer before writing of the first data.

The processor writes out data in the first buffer to the second storage and releases the first buffer when an amount of the data in the first buffer reaches a first predetermined value in writing of the first data into the first buffer.

The processor writes tail data of the first data, which has a size of the remainder, into the allocated area in the second buffer, writes the second data into an area starting from an address sequential to an end addresses of the allocated area in the second buffer, and writes out data in the second buffer to the second storage when an amount of the data in the second buffer reaches a second predetermined value in writing of the second data.

Below, embodiments will be described with reference to the drawings. The embodiments to be described below are merely an example, and the present invention is not necessarily implemented in the same forms as them.

### First Embodiment

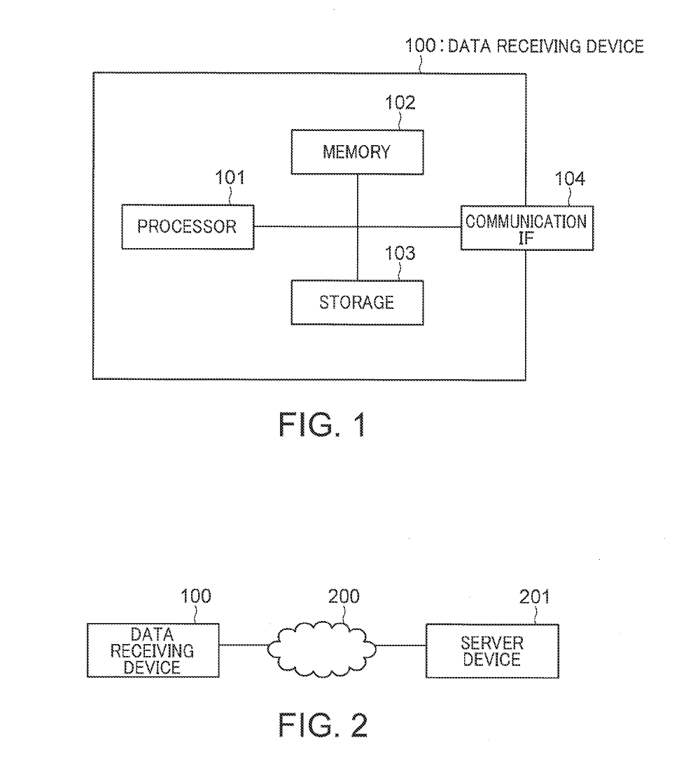

FIG. 1 shows the functional block diagram of a data receiving device 100 in a first embodiment. The data receiving device 100 includes a processor 101, a memory 102, a storage 103, and a communication interface 104. The processor 101, the memory 102, the storage 103, and the communication interface 104 are connected to one another via a bus.

The processor 101 executes programs such as an application program and an OS. The processor 101 manages the operation of this data receiving device.

The communication interface 104 is connected to a network (refer to FIG. 2 to be described hereafter) and communicates with the other devices on the network. Networks to be connected to the communication interface 104 include wired LANs in compliance with standards such as IEEE 802.3 and wireless LANs in compliance with standards such as IEEE 802.11. The communication interface is not limited to an interface connected to networks in these examples or may be of a type of a communication interface that makes a one-to-one connection. Alternatively, the communication interface may be of a type of a communication interface that makes a one-to-many connection. The communication interface 104 may any interface as long as it can be connected to a network in an electrical or optical manner. For example, the communication interface 104 may also be one that supports xDSL, WiMAX, LTE, Bluetooth, infrared rays, visible light communications, or the like.

The memory 102 is a storage (first storage) to store programs to be executed by the processor 101 and data items used in the programs (also including temporary data items). The memory 102 is also used as cache or buffer. For example, the memory 102 is used as a cache or buffer when the processor 101 reads/writes data items from/into the storage 103, or exchanges data items with the other devices via the communication interface 104. The memory 102 may be, for example, a volatile memory such as an SRAM and DRAM or may be a nonvolatile memory such as an MRAM.

The storage 103 is a storage (second storage) to permanently save programs running on the processor 101 and data items. The storage 103 is also used in the case of temporarily saving information items that cannot be stored in the memory 102 or in the case of saving temporary data items. The storage 103 may be any device as long as the data items can be permanently saved therein, and examples thereof include NAND flash memories, hard disks, and SSDs. In the present embodiment, the storage 103 is assumed to be a NAND flash memory. The I/O processing of the storage 103 is slower than that of the memory 102. That is, the speed in the storage 103 at which data items are read or written is lower than that in the memory 102. In a NAND flash memory, I/O processing is performed by a fixed-length block size, and it is efficient to read or write data items having lengths of integral multiples of a block length.

FIG. 2 is a schematic diagram of a communication network system including the data receiving device 100. The data receiving device 100 is connected to a server device 201 over a network 200 such as the Internet. The data receiving device 100 acquires data items such as web pages through communication with the server device 200. A web page typically includes various kinds of data such as movie data, audio data, and image data. The description will be made below taking the case of acquiring a web page, as an example.

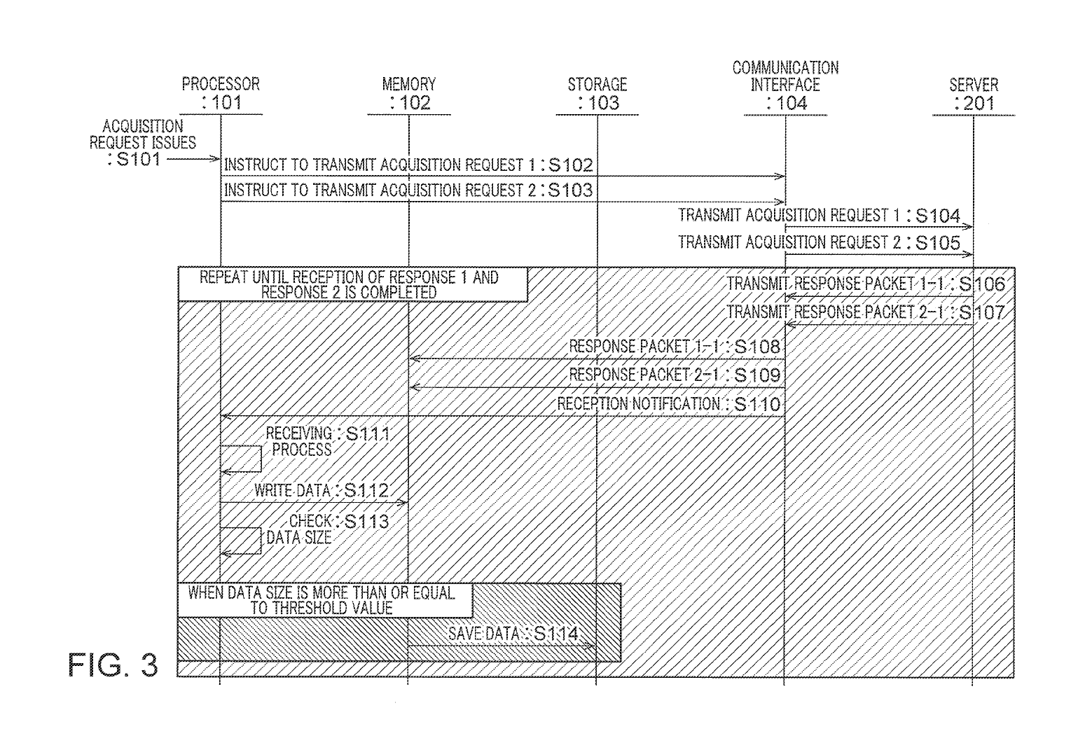

FIG. 3 shows the sequence of a process in which the data receiving device 100 acquires a web page from the server device 201. This sequence is started with an acquisition request for a web page made by a program that runs on the processor 101 (S101). It is assumed here that information items contained in the web page are concurrently acquired using two TCP connections.

The processor 101 transmits, using two TCP connections, transmission instructions on an acquisition request 1 and an acquisition request 2 to the communication interface 104, for example, continuously in this order (S102 and S103). The communication interface 104 transmits the acquisition request 1 and the acquisition request 2 to the server device 201 in accordance with the transmission instructions (S104 and S105). The acquisition request 1 and the acquisition request 2 may be acquisition requests for separate objects, respectively, or may be requests for separate data ranges of the same object. For example, by using HTTP Range fields or the like that can specify data ranges of an object, the first half of a file may be requested with the acquisition request 1, and the second half of the file may be requested with the acquisition request 2.

The communication interface 104 receives a response packet 1-1 and a response packet 2-1 that are transmitted from the server device 201 (S106 and S107). The response packet 1-1 is a response packet for the acquisition request 1, and the response packet 2-1 is a response packet for the acquisition request 2.

Here, data transmitted from the server device 201 is not always contained in one response packet, but may be divided into a plurality of separate response packets and transmitted. For example, when one packet can contain a data item having a size of 1500 bytes, an image data item having a size that cannot be contained in one packet is divided into a plurality of data items and contained in different response packets, respectively. In this case, a plurality of response packets, the first response packet 1-1 for the acquisition request 1, followed by a second response packet 1-2, a third response packet 1-3, and an X-th response packet 1-X, are received. Similarly, for the acquisition request 2, a plurality of response packets are received like the first response packet 2-1, followed by a second response packet 2-2, a third response packet 2-3, and a Y-th response packet 2-Y.

Hereafter, the set of the response packet 1-1 to the response packet 1-X may be denoted by a response 1, and the set of the response packet 2-1 to the response packet 2-Y may be denoted by a response 2.

When the communication interface 104 receives the response packets 1-1 and 2-1, the response packets 1-1 and 2-1 are once stored in the memory 102 (S108 and S109).

Thereafter, the communication interface 104 generates interrupts of reception notification to the processor 101 for the response packets 1-1 and 2-1, respectively (S110).

Upon detecting the reception notification, the processor 101 starts a receiving process (S111). In the receiving process, referring to the memory 102, the processor 101 extracts data items from payload portions in the response packets 1-1 and 2-1, and accumulates the extracted data items in a buffer that is allocated on the memory 102 (S112). To write data items into the buffer in the memory 102, a scheme in the present embodiment to be described hereafter is used (the tail of the data belonging to the response 1 and the head of the data belonging to the response 2 may be continuously written into the buffer). Note that the number of buffers to be allocated in the memory 102 is not limited to one. As will be described hereafter, three buffers are allocated in the example of the present embodiment.

Here, it is assumed that an area in the memory 102 that is used for a process of saving the response packets 1-1 and 2-1 from the communication interface 104 to the memory 102 (the processes of S108 and S109 in FIG. 3) is different from an area in the buffer to accumulate data items in the course of the receiving process (S111) and the data saving (S112).

It is determined whether the amount of data items written into the buffer on the memory 102 reaches a predetermined threshold value (predetermined value) in step S112 (S113). The predetermined threshold value (predetermined value) is identical to the size of the buffer. When the predetermined threshold value is reached, all the data items accumulated in the buffer on the memory 102 are read out and written into the storage 103 (S114). All the data items accumulated in the buffer are similarly read out and written into the storage 103 also in the case where the predetermined threshold value is not reached but the reception of the last packet belonging to the last response is completed, in the case where the buffer area on the memory 102 runs short, or in the case where the reception of data items is interrupted halfway. The buffer has a length of an integral multiple of a block length, which is the unit of reading or writing in the storage 103 (e.g., 512 bytes) and the writing is performed by an integral multiple of the block length, which allows for efficient writing to the storage. The buffer from which the data items have been read out is once released and reused to write subsequent data items belonging to the response 1 or the response 2.

Steps S106 to S114 are repeated until the reception of the response 1 (the response packet 1-1 to the response packet 1-X) and the response 2 (the response packet 2-1 to the response packet 2-Y) is completed.

As described above, by writing data items into the buffer on the memory 102 in step S112 using the scheme in the present embodiment to be described hereafter, it is possible to write the tail of the data belonging to the response 1 and the head of the data belonging to the response 2 at consecutive addresses in the storage 103.

That is, in a given block of the storage 103, the tail of the data belonging to the response 1 is followed by the head of the data belonging to the response 2 as long as the tail of the data belonging to the response 1 is not identical to a boundary between blocks.

The above is the basic operation of the data receiving device 100. There has been described here the method of acquiring a web page using two TCP connections, but more connections may be used for the acquisition. In addition, FIG. 3 shows the use of two TCP connections, through each of which one acquisition request is transmitted and the response thereto is received, but this correspondence relationship can also be changed. For example, using one TCP connection, a plurality of acquisition requests may be transmitted and a plurality of responses may be received. Such an operation may be only performed in conformity with the specifications of HTTP and will not be described in detail.

Hereafter, as the detail of the operation in step S112, a process of storing data items in a buffer allocated on the memory 102 will be described.

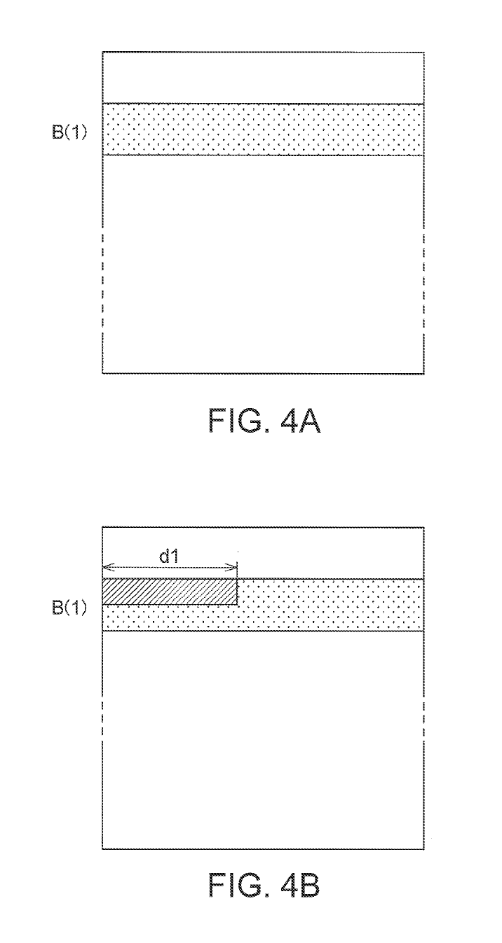

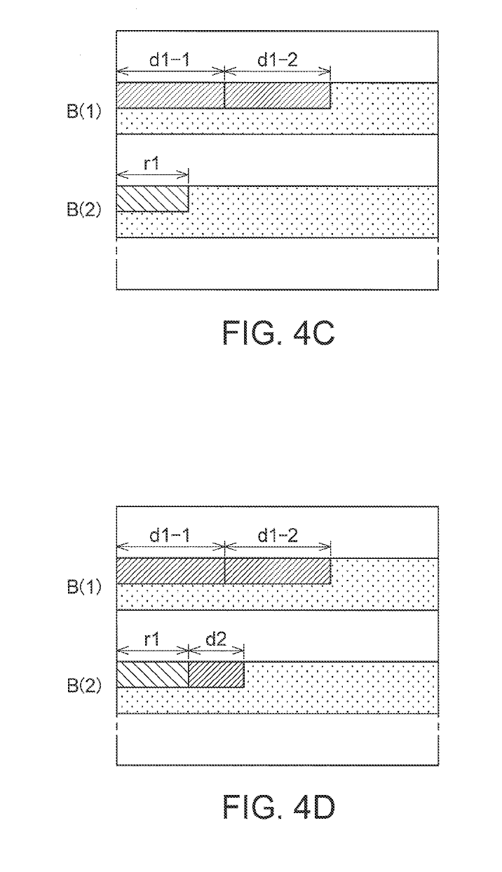

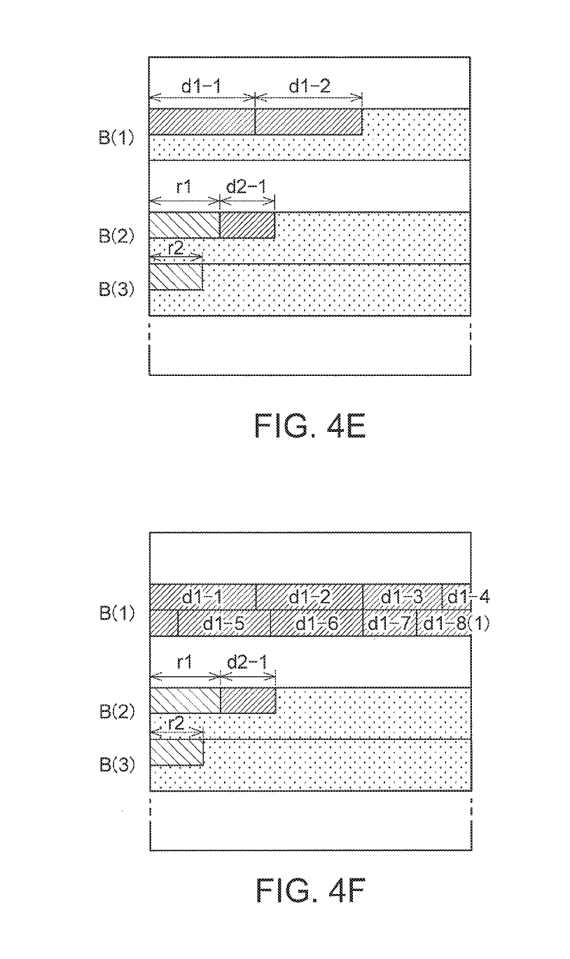

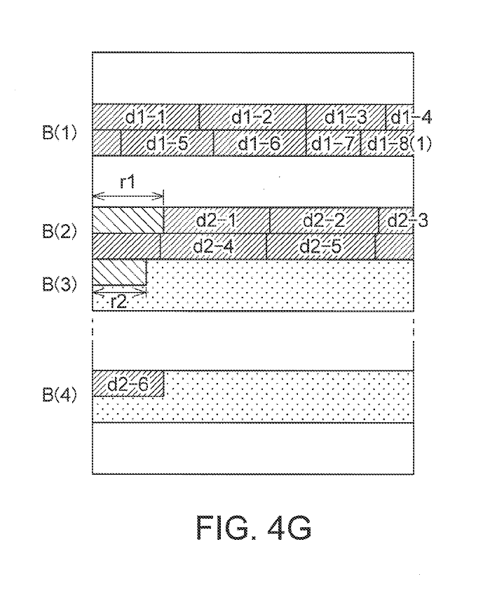

FIG. 4A schematically shows a buffer B(1) that is allocated on the memory 102.

It is assumed that addresses increase as seen from left to right, from up to down in the drawing. That is, when data items are stored from the head without gaps, they are to be stored from left to right and from up to down. In addition, the buffer B(1) is assumed to have a size L. This size L is a size with which access (reading and writing) to the storage 103 is efficiently performed. For example, in a device that is accessed by a block size, the size L is set to an integral multiple of the block size. In addition, when the storage 103 includes a cache or buffer, the size L may be set in accordance with the size of the cache or buffer. At this point, the size L does not need to be unified among the buffers, and a plurality of different sizes may be used as long as the sizes are integral multiples of the block size. For example, when the block size is denoted by Lb, the buffer size L may be n×Lb (n=natural number). In addition, the size L may be determined to be the largest n×Lb (n=natural number) below a size obtained by dividing the size of the memory 102 by (the number of connections)×2 or (the number of connections)×2+1. When the divisor is (the number of connections)×2+1, received data items can be buffered while data items are written out to the storage 103. Alternatively, a plurality of Ls may be defined to set buffers having different sizes. A buffer having a larger n may be allocated to a response having a higher priority. The priority may be determined in accordance with an acquisition request. For example, the priority may be determined in accordance with the type such as image and text, language, update frequency, size, the approval/disapproval of caching, and the effective period of cache, of an acquired data item.

Assume that the processor 101 starts the receiving process of the response packet 1-1 received in step S106 in FIG. 3 (S111). In addition, assume that no data item is stored the buffer B(1). The processor 101 first calculates a size d1 of data items that are received for the response 1 based on the received response packet 1-1. The size d1 of the data received for the response 1 indicates, in the case where there are a plurality of response packets 1-1 to 1-X, the total size of data items received for the response packets 1-1 to 1-X. Taking an example of communication under HTTP, the size d1 of data received for the response 1 can be calculated by performing receiving processes in layers up to the TCP layer on the response packet 1-1, thereafter extracting information on HTTP that is stored as a TCP data item, and analyzing the HTTP header thereof (more specifically, by acquiring the value of Content-Length header).

When the data size is calculated, the available buffer size that is currently allocated is checked. Since no data item is currently stored in the buffer B(1), the available size is L. At this point, the data size d1 and the buffer size L are compared to determine whether the data having the data size d1 (all data items belonging to the response 1) can be stored in the present buffer. If d1≦L, which means that the data having the data size d1 can be stored in the present buffer B(1), the data items of the response packet 1 are stored from the head of the buffer B(1). The result thereof is as shown in FIG. 4B. If the size of the response packet 1-1 is identical to the size d1, this is the completion of the reception of the response 1. If the size of the response packet 1-1 is less than the size d1, data items contained in the subsequent response packets 1-2, . . . may be stored one by one at consecutive addresses.

In contrast, if (the size d1 of data belonging to the response 1)>(the buffer size L), all the data belonging to the response 1 cannot be stored in the allocated buffer B(1). In this case, a quotient N1 and a remainder r1 of the data size d1 divided by the buffer length L are calculated. Then, the data belonging to the response packet 1-1 is stored in an available area in the buffer B(1) (from the head thereof in this case) and all the remaining areas in the buffer B(1) are reserved. Then, as shown in FIG. 4C, a new buffer B(2) is further allocated, and a portion having a size r1 from the head of the buffer B(2) is reserved as an area for the response 1. Note that a value obtained by dividing the total size of the data belonging to the response 1 and data items belonging to respective responses that have been received thus far (they does not exist here) by the buffer size L may be denoted by NN1 (NN1 is here identical to N1).

If (the data size d1) (the buffer size L) or if (the data size d1)>(the buffer size L), when the data belonging to the response 1 is divided into a plurality of packets and transmitted, the data items in the respective response packet 1-1, the response packet 1-2, . . . are stored one by one in the buffer B(1). At this point, they are written at positions that follow the data belonging to the immediately preceding response packet 1-1. For example, as shown in FIG. 4C, the data item received for the response packet 1-1 and the data item received for the response packet 1-2 are written one by one at consecutive addresses. Reference character d1-1 denotes the size of the data item received for the response packet 1-1, and reference character d1-2 denotes the size of the data item received for the response packet 1-2. If the buffer B(1) is filled, all the data items in the buffer B(1) are written out to the storage 103, the buffer B(1) is released, and the data items of further subsequent response packets for the response 1 are written from the head of the buffer B(1) (if the quotient N1 is two or more). The detail thereof will be described hereafter with reference to FIG. 4F. Note that data having the size r1 at the tail of the data belonging to the response 1 is written into the reserved area having the size r1 at the head of in the buffer B(2).

Note that, in FIG. 4C, the buffer B(1) is not followed by the buffer B(2) and are at separate positions, but the buffer B(1) may be followed by the buffer B(2).

FIG. 4A, FIG. 4B, and FIG. 4C show the example of securing a buffer for the response 1, and a buffer is similarly allocated for the response 2. In the state of FIG. 4C, it is assumed that the first response packet belonging to the response 2 (response packet 2-1) is received. As with the case of the response 1, a size d2 of data belonging to the response 2 is calculated. As with the case of the response 1, it is checked whether the data having the size d2 can be stored in a current available area in the buffer. In the state of FIG. 4C, a portion of the buffer B(1) is available but is reserved for the response 1, and thus an available area in the buffer B(2) is used. The size of the available area in the buffer B(2) is L−r1 (=L′).

If d2≦L′, all the data belonging to the response 2 can be stored in the available area in the buffer B(2) as shown in FIG. 4D. If the data size of the response packet 2-1 is identical to the size d2, this is the completion of the reception of the response 2. If the data size of the response packet 2-1 is less than d2, data items contained in subsequent response packets 2-2, . . . are stored one by one at consecutive addresses with respect to the data items of the response packet 2-1.

In contrast, if d2>L′, a quotient (denoted by N2) and a remainder (denoted by r2) of a length that is the subtraction of the available area size L′ in the buffer B(2) from the data size d2 by the size L are calculated. That is, N2=(d2−L′)/L, and r2=(d2−L′) mod L. Reference character N2 denotes the quotient, and reference character r2 is the remainder. Then, as shown in FIG. 4E, a buffer B(3) is newly allocated, a size r2 from the head of which is set as reserved for the response 2. Shown reference character d2-1 denotes the size of the data item contained in the response packet 2-1. The data items of the response packets 2-2, . . . that are subsequent to the response packet 2-1 are written at positions following the data item belonging to the immediately preceding response packet 2-1. If the buffer B(2) is filled, all the data items in the buffer B(2) are written out to the storage 103 (the data item having the size r1 at the tail of the data belonging to the response 1 is also made to have been written into at the head of the buffer B(2)), the buffer B(2) is released, and the data items of further subsequent response packets for the response 2 are written from the head of the buffer B(2) (if N2 is one or more). Note that the data item having the size r2 at the tail of the data belonging to the response 2 is written into the reserved area having the size r2 at the head of the buffer B(3). Note that a value obtained by dividing the total size of the data belonging to the response 2 and the data belonging to respective responses that have been received thus far (only the response 1 here) by the buffer size L may be denoted by NN2. Here, in FIG. 4C, while the response 1 is being saved in the buffers, there are two buffers in use, B(1) and B(2). If the reception of the response 2 is started in this state, an additional buffer, a buffer B(3), is needed as shown in FIG. 4G. If N2>1, the number of buffers needed while the response 2 is being saved is further increased by one, which needs a buffer B(4), and the four buffers are needed in total. Note that, the data item of a packet 2-6 is stored in both of the buffer B(2) and the buffer B(4). In such a manner, the number of buffers needed to save a response is (the number of responses)×2. If buffers of (the number of responses)×2+1 are prepared, it is possible to buffer the responses while data is being written out to the storage.

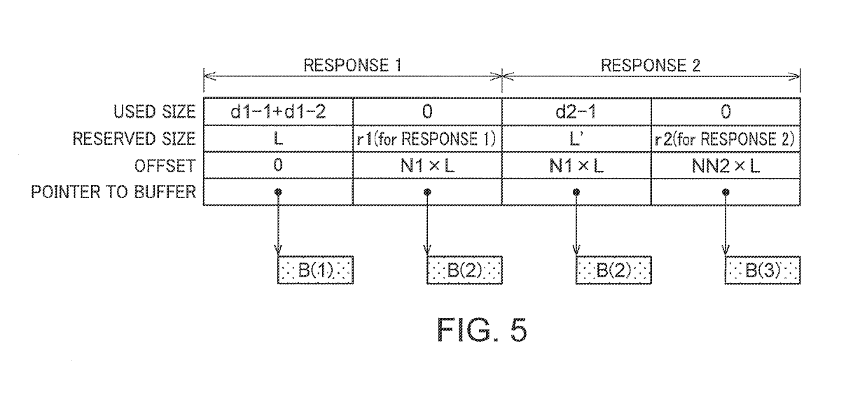

Here, buffer management information will be described. FIG. 5 shows an example of buffer management information. A buffer to be allocated on the memory 102 is managed with the buffer management information. The shown buffer management information is for the response 1 and the response 2, which corresponds to the state of FIG. 4E.

With respect to the response 1, for each of the buffer B(1) and the buffer B(2), a used size, a reserved size, an offset, and a pointer indicating the position of the buffer in the memory 102 are held. The offset that indicates a length from the head of the data belonging to the response 1 (a length from the head position of the storage to store the data belonging to the response 1) is set in units of integral multiples (more than or equal to zero) of a buffer size. Similarly, with respect to the response 2, for each of the buffer B(2) and the buffer B(3), a used size, a reserved size, an offset indicating a length from the head of the data belonging to the response 2 (a length from the head position of the storage to store the data belonging to the response 2), and a pointer indicating the position of the buffer in the memory 102 are held. To access the buffer, the position of the buffer is specified using the pointer. NN1 in FIG. 5 is, as described above, a value obtained by dividing the size of the data belonging to the response 1 by the buffer size L (here, identical to N1). NN2 is, as described above, a value obtained by dividing the total size of the data belonging to the response 2 and the data belonging to respective responses that have been received thus far (here, only the response 1) by the buffer size L. Note that, in the case where buffer sizes differ according to the buffers, the offset may be calculated with a similar idea.

The used size in the buffer management information is a size by which data is actually written. The used size is updated when data is written into a buffer. For example, in the state of FIG. 5, when the data having the size r1 at the tail of the data belonging to the response 1 is written into the buffer B(2), the used size in the buffer B(2) for the response 1 is updated to r1, and the used size in the buffer B(2) for the response 2 is updated to r1+d2−1. The reserved size is a size that is reserved by the response in question. Assume that, as to a reserved area, an earlier response (a response reserved earlier) reserves an area closer to the head side of a buffer. For example, assume that, in the buffer B(2), the response 1 reserves an area having the size r1 at the head, and the response 2 reserves an area having the size L′ subsequent to the area having the size r1. The offset indicates, as described above, the position of the data belonging to the response 1 from the head in units of integral multiples (more than or equal to zero) of the buffer size. When writing out from a buffer to the storage 103 is performed, the value of the offset is incremented by the buffer size L. For example, in the state of FIG. 5, when the data in the buffer B(1) is written out to the storage 103, the buffer B(1) is released, and subsequent data belonging to the response 1 is written from the head of the buffer B(1), the offset is updated from zero to L. Next, similarly, when data is written into and data is written out from the buffer B(1) and the buffer is released, the offset value is updated to 2×L.

FIG. 5 is the case where the number of responses is two (the response 1 and the response 2), and when the number of responses, such as a response 3, a response 4, . . . , increases, pieces of buffer management information are added accordingly. Note that the update of the buffer management information is performed, as will be described hereafter, when a buffer is newly set, when data is written into a buffer, when data is written out from a buffer to the storage 103, and the like.

The buffer management information is here held in the form of a list but may be held in the form of a table. Alternatively, a piece of information in the buffer management information for each buffer may be disposed at the head of each buffer in the memory 102, and in this case, only information on pointers may be separately managed in a form of a list, a table, or the like. Alternatively, as a form other than those described here, for example, a bitmap or the like may be used to manage the buffer management information on a used memory and an available memory. For example, buffer management information on the arranged bitmap may be managed so that bits are arranged from the address of the head in such a manner as to, for each address or every optional number of bytes, put 1 when a buffer area is used or put 0 if it is unused.

FIG. 4F shows the state that the reception of the data relating to the response 1 proceeds from the state of FIG. 4E. Assume that a response packet 1-3, response packet 1-4, response packet 1-5, response packet 1-6, response packet 1-7, response packet 1-8 are received after the response packet 1-1 and the response packet 1-2. The lengths of the data items of the response packet 1-3, the response packet 1-4, the response packet 1-5, the response packet 1-6, the response packet 1-7, and the response packet 1-8 are d1-3, d1-4, d1-5, d1-6, d1-7, and d1-8, respectively. The data item of the response packet 1-3 (having the data size d1-3) is stored subsequently to the data item of the response packet 1-2, the data item of the response packet 1-4 (having the data size of d1-4) is stored subsequently to the data item of the response packet 1-3, and thereafter similarly, the data items of the response packet 1-5 and subsequent response packets.

Here, the tail of the data item of a response packet 1-8 that is received last is not always coincident with the tail of the buffer B(1). That is, the size of an available area in the buffer B(1) after the data item of a response packet 1-7 is stored, that is, a fractional size being a size obtained by subtracting the total size of the data items of the response packet 1-1 to response packet 1-7 from the size L of the buffer B(1) is not always identical to the length d1-8 of the data item of the response packet 1-8. They are not identical to each other if the above-described r1 is not zero, and they are not identical to each other in this example. In this case, in the buffer B(1), a data item that has the above-described fractional size (denoted by d1-8(1)) from the head out of the data item of the response packet 1-8 is stored in an area having the fractional size at the end of the buffer B(1), and a data item that has the remaining size (d1-8(2)) is stored in the reserved area r1 in the buffer B(2). Note that the size d1-8(2) is identical to r1.

The example of FIG. 4F is an example in which the data belonging to the response 1 has a size of L+r1, if the size is 2L+r1 and the response packets arrive in sequence, the writing of data having the size L is performed twice on the buffer B(1) (i.e., the buffer B(1) is used twice), and thereafter the last data item having the size r1 is written into a reserved area having the size r1 at the head of the buffer B(2).

As mentioned in the description of steps S113 and S114 in FIG. 3, it is determined whether the amount of data accumulated in the buffer reaches a threshold value (the buffer size L) when a data item is written into a buffer. That is, when a data item is stored in the buffer, it is judged whether the whole one buffer is filled. If the amount of data reaches the threshold value, all the data stored in the buffer is read out from the buffer and written at a predetermined position in the storage 103. Thereafter, the buffer (memory) is released and returns to an unused state. Here, releasing a buffer may be a process of rendering a used area to a state that it can be used for the other purposes, or may be made into a process of setting zero to a used size contained in buffer management information.

In addition, the predetermined position in the storage 103 is determined based on an “offset” contained in buffer management information. For example, when the offset is zero, all the data read out from a buffer is written at a reference position in the storage 103, or when the value of the offset is X, all the data is written at a position advanced by X bytes from the reference position.

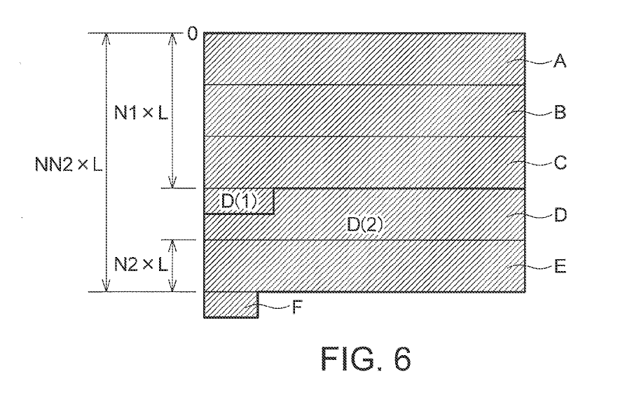

FIG. 6 shows a writing state of the storage 103 when the receiving process for the response 1 and the response 2 is completed. The example of FIG. 6 is the case where d1>L is satisfied for the data size d1 of the response 1, and d2>L′ is satisfied for the data size d2 of the response 2, where N1=3 and N2=1. That is, the data size d1=3×L+r1 and the data size d2=L′+1×L+r2. Writing, reading, and releasing of buffer B(1) are repeated three times, and the data belonging to the response 1 is written into areas A to C in the storage 103 for the respective times. In addition, writing, reading, and releasing of the buffer B(2) are repeated twice, and data is written into an area D and an area E in the storage 103 for the respective times. The data stored in an area D(1) on the head side of the area D is a data having the size r1 at the tail of the data belonging to the response 1. The data stored in an area D(2) of the area D is the data on the head side of the data belonging to the response 2. The data written in the area E in the storage 103 is the subsequent data belonging to the response 2. Data written in an area F is data having a size r2 at the tail of the data belonging to the response 2. Here, there has been described the case, by way of example, of acquiring the data on two responses using two TCP connections at the same time, but the acquisition can be performed even when the number of responses to be acquired is increased.

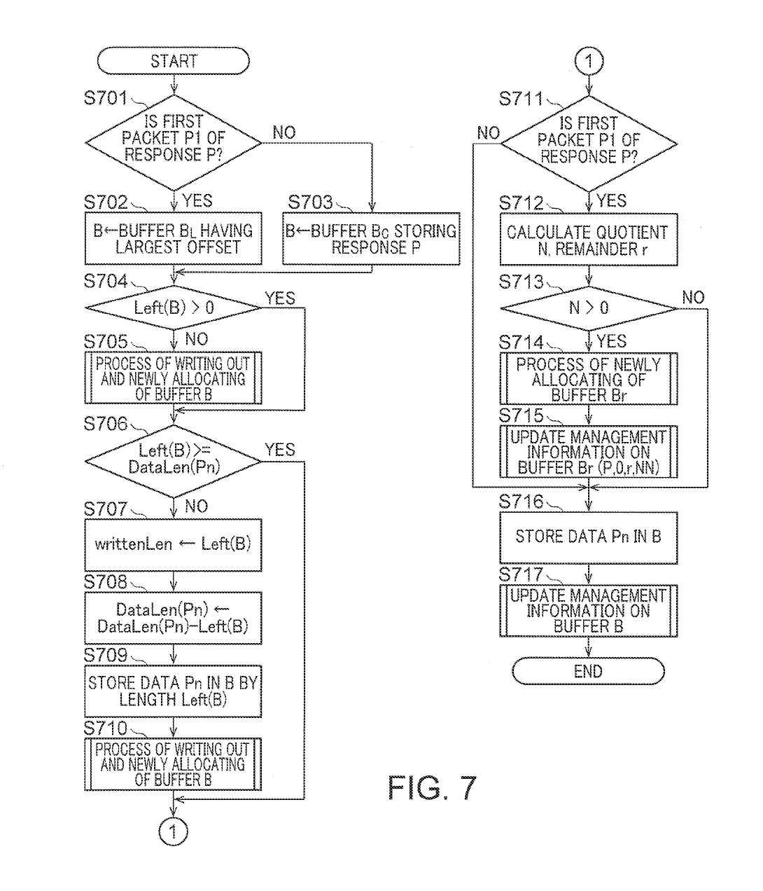

FIG. 7 is a flow chart showing a basic flow of a process by the data receiving device in FIG. 1. Note that the operation of this flow chart is merely an implementation example and the details thereof may differ as long as the basic idea is not changed.

It is checked whether a received packet is a first packet P1 of a response P (step S701). In the example of FIG. 3, it is checked whether the received packet is the first packet 1-1 or 2-1 of the response 1 or the response 2. Note that the expression “first packet” is for convenience's sake, and more precisely, it is checked whether the received packet is a packet that contains data size information on the response P. In addition, packets belonging to the response P have been denoted thus far by P-1, P-2, . . . , P-X, but the description of this flow uses expression omitting “-,” such as P1, P2, . . . , PX.

When the received packet is the first packet (step S701—YES), a buffer having the largest offset (denoted by a buffer B_{L}) is found from among buffers that are managed at that point, and the buffer B_{L} is determined as a buffer B to be operated (step S702). In the drawing, this is expressed as “B←the buffer B_{L} having the largest offset.” As a specific example of step S702, in the case where the response P is the response 1, the buffer B(1) is specified as the buffer B_{L} (only the buffer B(1) existing). In the case where the response P is the response 2, the buffer B(2) is specified as the buffer B_{L} (at this point, the buffers B(1) and B(2) are managed and the offset N1×L of the buffer B(2) is the largest).

In contrast, if the received packet is not the first packet (step S701—NO), a buffer in which data belonging to the response P is stored (denoted by a buffer B_{c}) is found, and the buffer B_{c} is determined as the buffer B to be operated (step S703). In the drawing, this is expressed as “B←the buffer B_{c} having the largest offset.”

When the buffer B to be handled is settled, it is checked whether the buffer B has any available area. That is, it is checked whether the size of an available area in the buffer B (denoted by Left(B)) is larger than zero. If there is no available area, that is, the size Left(B) of the available area is zero (step S704—NO), all the data items in the current buffer B are written out to the storage 103, the buffer B is released, and the released buffer B is set as a new buffer B (step S705). The process of step S705 will be described below in detail as the writing out and newly allocating processes for the buffer B. In contrast, if there is an available area in the buffer B, that is, the size Left(B) of the available area is larger than zero (step S704—YES), the flow skips the process of step S705 and proceeds to step S706.

In step S706, it is checked whether a data item contained in the packet received in step S701 (a packet Pn being processed, where n is an integer more than 1) can be stored in the available area in the buffer B. The size of the data item contained in the packet Pn is denoted by Datalen(Pn). If the whole data contained in the packet Pn can be stored in the available area in the buffer B (step S706—YES), that is, if the size Left(B) of the available area in the buffer B is larger than or equal to Datalen(Pn), the flow proceeds to step S711 to be described hereafter. If only a part of the data contained in the packet Pn can be stored in the available area in the buffer B (step S706—NO), that is, if Datalen(Pn) is smaller than the size Left(B) of the available area in the buffer B, the flow proceeds to step S707.

In step S707, the value of the size Left(B) of the available area in the buffer B is saved in a parameter (writtenLen). Then, the value of Datalen(Pn) is updated by subtracting the size (Left(B)) of the available area in the buffer B from the data size Datalen(Pn) of the packet Pn (step S708).

Out of the data item of the packet Pn, a data item having the size Left(B) of the available area in the buffer B is specified from the head thereof, and the data item is stored in the available area in the buffer B (step S709). Then, all the data items in the buffer B are written out to the storage 204, and the buffer B is released, and the released buffer B is set as a new buffer B (step S710). The new buffer to store the remaining data of the data item of the packet Pn (the data having the size Datalen(Pn) updated in step S708) is thereby allocated. The process of step S710 will be described below in detail as the writing out and newly allocating processes for the buffer B.

After step S710, it is determined again whether the packet belonging to the response P received in step S701 has been the first packet P1 of the response P (step S711). If the packet belonging to the response P is not the first packet P1 (step S711—NO), the flow proceeds to step S716 to be described hereafter.

If the packet received in step S701 is the first packet P1 of the response P (step S711—YES), a buffer is newly allocated in accordance with the size of the data belonging to the response P (the length of all the data to be received for the response P (the packets P1 to PX)). Specifically, the following steps S712 to S715 are performed. Assume that the size of the data belonging to the response P is denoted by a parameter ContentLen(P). A quotient N and a remainder r are calculated by subtracting writtenLen (the value calculated in step S707. The size of data written into the available area in the buffer B if the data item of the first packet P1 is larger in size than the available area in the buffer B. i.e., the size of the available area in the buffer B) from ContentLen(P) and dividing the subtraction result by the buffer length L (step S712). That is, the quotient N is calculated by (ContentLen(P)−writtenLen)/L, and the remainder r is calculated by (ContentLen(P)−writtenLen) % L.

Then, if the quotient N is not zero (i.e., if the quotient N is greater than zero) (step S713—YES), an additional buffer (denoted by a buffer Br) is allocated on the memory 102 (step S714), management information on the buffer Br (refer to FIG. 5) is initialized (step S715), and the flow proceeds to the next step S716. This process may also be performed if the remainder r is zero. The process of step S714 will be described in detail below as a newly allocating process of the buffer Br, and the process of step S715 will be described in detail below as an updating process of the management information on the buffer Br.

In contrast, if the quotient N calculated in step S712 is zero (step S713—NO), the flow skips the processes of steps S714 and S715 and proceeds to step S716.

In step S716, the data item of the packet Pn is stored in the buffer B to be operated.

Then, the buffer management information on the buffer B is updated (step S717), and the process is finished. The process of step S717 will be described in detail below as the update of the management information on the buffer B.

Some steps included in the above-mentioned series of processes will be described below in more detail.

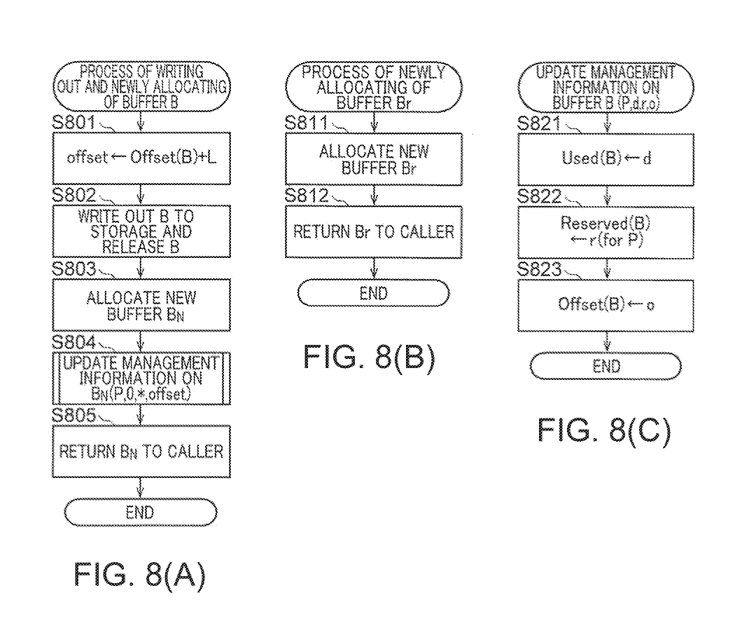

FIG. 8(A) is a flow chart of the writing out and newly allocating processes for the buffer B that is performed in step S705 and step S710. A value obtained by adding the buffer length L to an offset Offset(B) in the management information on the buffer B to be handled is saved as an offset (step S801). In the drawing, this is expressed as “offset←Offset(B)+L.”

Next, all the data items in the buffer B are written out to the storage 103, and the buffer B is released (step S802).

The released buffer B is allocated as a new buffer B_{N} (step S803), and buffer management information on the buffer B_{N} is initialized (step S804). Specifically, update parameters (P,d,r,o) are set first, denoting, from the left, the identifier of a response (P for the response P), a used size, a reserved size, and an offset. The parameters are set here to be (P,0,*,offset). To the parameter “*,” a required value may be set. As an example, it is conceivable to set L to the parameter “*” in the case where the buffer Br is allocated in step S714, and the buffer B being a current object is not the buffer Br. Alternatively, in the case where all the subsequent data belonging to the response can be written into the buffer B, the size of the data may be set to the parameter “*.” Next, an updating flow for updated information on the buffer B shown in FIG. 8(C) is performed. That is, a used size Used(B) in the management information on the buffer B is updated to “d” (here, zero) in step S821, a reserved size Reserved(B) in the management information on the buffer B is updated to “r” (here, zero) in step S822, and an offset Offset(B) is updated to “o” (here, the offset saved in step S801) in step S823. Referring back to FIG. 8(A), the buffer B_{N} allocated in step S803 is returned to the caller (step S805) in step S805, and the process is finished. Thereafter, the allocated buffer B_{N} is treated as the buffer B to be operated.

FIG. 8(B) is a flow chart of a newly allocating process on the buffer Br performed in step S714. The buffer Br is allocated as needed when the first packet P1 of a given response P is received, in order to store the above-mentioned fractional data (data having a remainder size). In this process, a new buffer Br is allocated (step S811), and the buffer Br is returned to the caller (step S812). The buffer Br is a buffer having a reserved area to store, in its head portion, the fractional data at the tail of the data belonging to response P (the data having the remainder size). For this reason, parameters (P,0,r,NN) are set as the update parameters (P,d,r,o) in step S715, and the updating flow for updated information on the buffer B shown in FIG. 8(C) is performed. NN is an offset, which is (the value NN obtained by dividing the total size of the data belonging to the response P of this time and the data belonging to the responses that have been received thus far by the buffer size L)×L. Thereby, the reserved size of the management information on the buffer Br is set to r, and the offset thereof is set to NN×L. Note that r is the remainder calculated in step S712.

FIG. 8(C) shows the updating flow for the management information on the buffer B (including the case of Br), which is performed, as mentioned above, in step S715 of FIG. 7 or in step S804 of FIG. 8, and is further performed in step S717. The processes of this flow when performed in steps S715 and S804 have been already described, and the process of this flow performed in step S717 will be described here.

The management information on the buffer B contains, as shown in FIG. 5, a used size, a reserved size, an offset, and a pointer to the buffer for the response P. Note that, as mentioned above, the update of the pointer to the buffer will not be described. The response, the used size, the reserved size, and the offset associated with the buffer are denoted by (P,d,r,o), and the response P, the used size Used(B), the reserved size Reserved(B), and the offset Offset(B) of the buffer management information are updated with “P,” “d,” “r,” and “o.” Then, in the process of step S717 of FIG. 7, Used(B) is updated by adding DataLen(Pn) to Used(B), and P, Reserved(B), and Offset(B) maintain their current values.

In the sequence shown in FIG. 3, only two acquisition requests are transmitted, but the number of transmitted acquisition requests varies according to applications running on the processor 101. At this point, when the last response packet for the last acquisition request is received, the processor 101 performs a process of writing out the data in the allocated buffer to the storage 103 (even if the amount of the data in the buffer does not reach the threshold value) to release the buffer.

In addition, if the reception for a given response has not been normally completed in the course of communication (e.g., if the reachability to the server device 201 is lost in the middle of the reception for some reason), a portion up to which the reception has been completed may be written out to the storage 103 and a portion at which an error has occurred may be discarded. At this point, the writing out to the storage 103 may be performed not in units of packets but in units of responses. For example, if an error occurs before the reception of a response Q is normally completed when the response P and the response Q are simultaneously received. In this case, the writing out may be performed on only the response P after waiting the reception of the response P to be completed, or the writing out may be performed on only the other response (neither P nor Q), the reception of which has been completed at the time of the occurrence of the error. Note that, the writing out is performed in units of packets. It can be detected that a given response is in the middle of reception by referring pieces of management information on the buffers. Note that, when the exception handling as described here is performed, the writing out to the storage is not necessarily performed on data having an integral multiple a block size.

In addition, as above-mentioned FIG. 6, in the case where the response 1 and the response 2 are received and the data is written out to the storage, assume that the reception of the data belonging to the response 1 to be stored in the area D(1) has not been performed yet at the time when the reception of the data belonging to the response 2 to be stored in the area D(2) is completed. In this case, the writing out to the buffer may be kept on standby until the reception of the data to be stored in the area D(1) is completed. In this case, the subsequent data belonging to the response 2 may be temporarily saved in the other area, and the saved data may be written into the buffer when the writing out and the release of the buffer is completed.

As described above, according to the present embodiment, at the time of saving data belonging to a response that is received over a network in a storage, it is possible to increase the speed of data receiving and storage saving, by once storing data belonging to a plurality of responses, which can be irregularly received, in a buffer having a size (a size of an integral multiple of a block size) with which the storage is accessed highly efficiently. At this point, based on the size of data to be saved and a buffer length, by securing a buffer having a reserved area for a given response and saving data belonging to the next response from immediately behind the reserved area, it is possible to save data items belonging to a plurality of responses in correct buffers even if the responses are simultaneously received. Furthermore, since the data receiving and storage saving can be managed with only a small buffer even if data belonging to a response is larger than a buffer size, it is possible to reduce a required amount of memory to acquire information (e.g., a web page) from a server.

### Second Embodiment

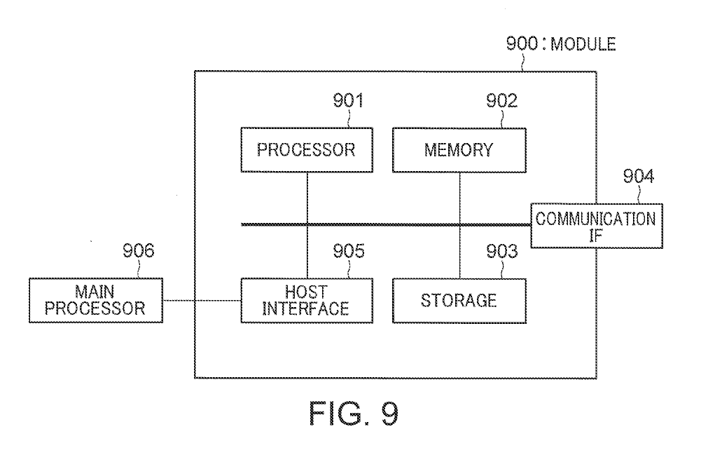

The present embodiment is the case where a function that achieves the same operation as in the first embodiment is implemented as a module. This module additionally has a function of exchanging control information with an external main processor, as well as a function of exchanging data items that are transmitted and received over a network, with the main processor. FIG. 9 shows a block diagram of a data receiving device in a second embodiment, which includes a module and a main processor. A module 900 is a part that has a main function in the present embodiment.

The module 900 includes a processor 901, a memory 902, a storage 903, a communication interface 904, and a host interface 905. The module 900 may be configured as a communication card such as a network card.

The processor 901, the memory 902, the storage 903, and the communication interface 904 have the same functions of the processor 101, the memory 102, the storage 103, and the communication interface 104 in the first embodiment, respectively, and basically operates likewise. However, to the processor 901, a function of exchanging data with the main processor 906 is added. The host interface 905 provides a function of connecting the module 900 and the main processor 906. The implementation thereof may be in conformity with the specifications of external buses such as SDIO and USB, or may be in conformity with the specifications of internal buses such as PCI Express. On the main processor 906, an OS and application software run, and a device driver for making use of the module 900, a communication application, and the like run.

Note that FIG. 9 shows that the main processor 906 is directly connected to the module 900 via the bus, but a host interface or the like may also be provided on the main processor 906 side, via which the module 900 is connected. In addition, FIG. 9 does not show devices other than the processor 906 as the peripheral devices of the module 900, but it is assumed that peripheral devices required to make the module 900 operate as a computer, such as a memory and displaying device, are connected as appropriate.

The module 900 starts its operation under an instruction from the main processor 906. Specifically, the main processor 906 issues an instruction equivalent to an acquisition request described in the first embodiment to the processor 901 via the host interface 905. The processor 901 grasps the detail of the instruction and performs the same operation as in first embodiment. That is, the processor 901 acquires a data item requested with the acquisition request from an external server and accumulates the data item in the storage 903 while performing proper buffer management in the memory 902.

In addition, the module 900 has a function of transferring the data items accumulated in the storage 903 to the main processor 906 under an instruction from the main processor 906. According to the buffer management scheme in the present embodiment, data items acquired with consecutive acquisition requests from the processor 906 are recorded in consecutive areas in the storage 903. It is therefore possible to efficiently acquire data items instructed from the main processor 906 by properly scanning the storage 903 and consecutively reading out object areas. Note that, by making use of the locality of information, a plurality of consecutive areas in the storage 903 may be read before a reading instruction is received from the processor 906 and the read-out data may be transferred in advance to the processor 906 (or a memory or the other storage device connected to the processor 906).

Note that control commands defined on the host interface 905 may be used for instructions that are exchanged between the module 900 and the main processor 906 (e.g., commands defined in the SD interface specifications), or a new command system may be constructed based on the control commands (e.g., those making use of vendor specific commands or vendor specific fields defined in the SD interface specifications or the like). In addition, if the main processor 906 can perform the reading or writing of the storage 903 in some manner, the main processor 906 may store an instruction to the processor 901 in the storage 903, and the processor 901 may read out, analyze, and execute the stored instruction. For example, a file containing an instruction may be saved in the storage 903, and the execution result of the instruction may be saved in the storage 903 as the same or the another file, and the main processor 901 may read out this file.

In addition, before receiving an instruction from the main processor 906, the module 900 may be turned on under the control of the main processor 906, or may be switched from a low-power-consuming state to a normal-operation-enabled state. Then, the module 900 may spontaneously turn itself off or may switch itself to the low-power-consuming state when a series of processes are completed (i.e., when the data saving into the storage 903 is completed). The low-power-consuming state may be brought by stopping power supply to some blocks in the module 900, reducing the operation clock of the processor 901, or the other methods. Furthermore, notification of the completion of the data saving into storage 903 may be provided to the main processor 906. These mechanisms allow the consumed energy of the module 900 to be reduced.

### Third Embodiment

In the first and second embodiments, there is no relationship such as independence or dependence established between acquisition requests. In contrast thereto, in the present embodiment, master-servant relationship is added to between acquisition requests. That is, an acquisition request that has been issued first and an acquisition request that is derived therefrom form an acquisition request group, and at least data items acquired in response to the respective acquisition requests belonging to the acquisition request group are saved in consecutive areas in the storage 103 or the storage 903.

The definition of the first issued acquisition request and the derived acquisition request is that, in the case where the result of processing the first acquisition request finds the existence of a data item that is to be necessarily acquired, an acquisition request for the latter piece of information is defined as a derived acquisition request. Such a derived acquisition request can be seen in, for example, an acquisition request for a web page. In the acquisition of a web page, the acquisition and analysis of the first HTML lead to new acquisition of data such as a style sheet, a script file, and an image file that are referred to by the HTML file. In the present embodiment, these acquisition requests for data items are regarded as one acquisition request group so as to cause these data items to be saved in consecutive areas in the storage 103 or the storage 903.

The function in the present embodiment is applicable to both the first embodiment shown in FIG. 1 and the second embodiment shown in FIG. 9. There will be described first about the application to the first embodiment, and next the application to the second embodiment.

### Application to First Embodiment

The processor 101 has, a function of acquiring data items of information (HTML) and the like, as well as a function of analyzing the acquired data (HTML), a function of extracting URLs that are found to be referred to from the data items as a result of the analysis (e.g., a style sheet, a script file, an image file), and a function of acquiring data items that are specified with the extracted URLs. These functions may be achieved as an application including a user interface such as a web browser, or may be achieved as a back-end application including no user interface. In the case of a back-end application, a web browser or the like operates as a front end. There will be described here the case where these functions are achieved as a back-end application, but these functions may be achieved as an application including a user interface.

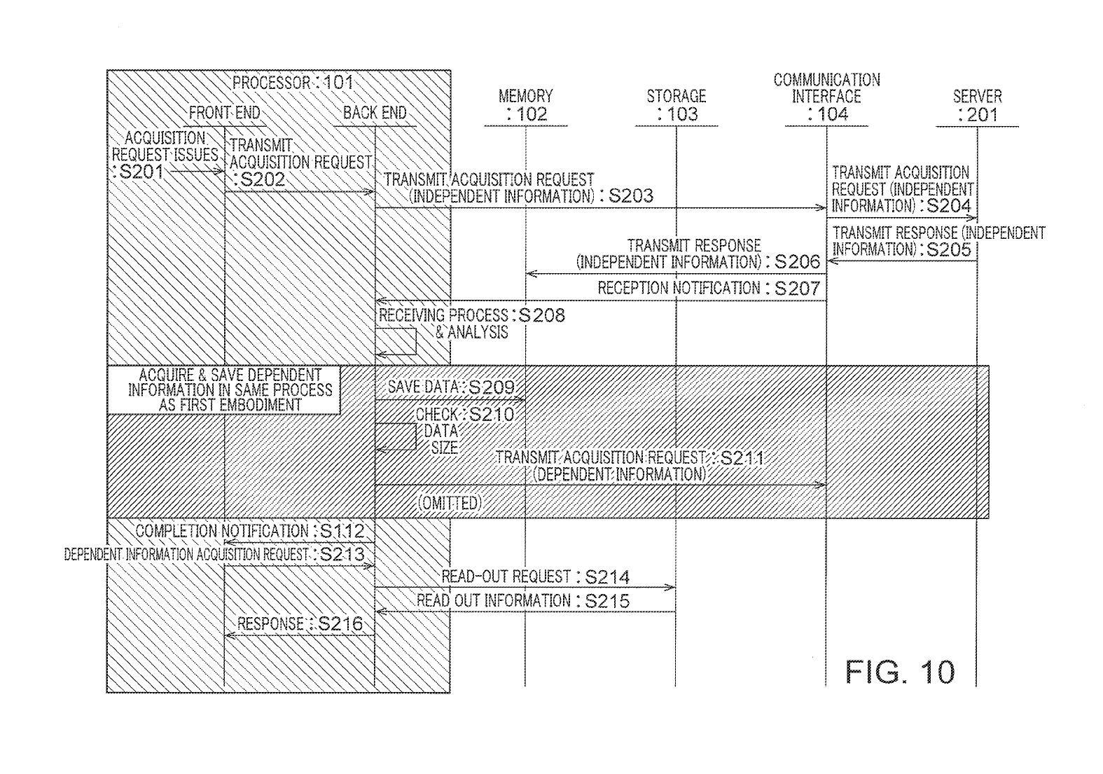

FIG. 10 is a sequence diagram of an operation in a third embodiment. A front end (web browser) generates an acquisition request (S201), and the front end transmits the acquisition request to a back-end application (S202). This request is typically an acquisition request for an HTML file. When receiving this acquisition request, the back-end application that achieves the present embodiment acquires data items that are acquisition objects of the acquisition request (hereafter, referred to as independent information) from a server (S202, S203, S204, S205, and S206). Thereafter, the back-end application analyzes the acquired independent information (S207 and S208), performs processes of writing the independent information into a buffer, judging whether the total written size of the buffer reaches a threshold value, and writing into a storage in the case of reaching the threshold value, and the like (S209 and S210), and concurrently therewith, spontaneously acquiring data items that are referred to from URLs contained in the independent information (hereafter, referred to as dependent information) (S211). The acquisition, buffer writing, threshold value judgment, storage writing, and the like of dependent information is similar to those of independent information. That is, a plurality of pieces of dependent information that are referred to from independent information are acquired from a server, and the acquired plurality of pieces of dependent information are stored in the storage via the buffer.

These processes are similar to those in the first embodiment, and will not be shown in a detailed sequence. In such a manner, the independent information and the dependent information thereof are stored in the storage according to the buffer storing method described in the first embodiment. Note that the URLs that are referred to from independent information may be read out from the buffer and grasped before the independent information is written into the storage, may be read out from the storage and grasped after being written into the storage, or may be grasped before the independent information is written into the buffer.

In the end, when all the independent information and the corresponding dependent information are stored in the storage, the back-end application notifies its completion to the front end (S212). At this point, the information for which an acquisition request is first made (i.e., the independent information) is transmitted together as a response. Thereafter, the front end receiving the completion notification and the independent information generates an acquisition request for dependent information and transmits the acquisition request to the back end (S213). The back end makes a reading request for these pieces of dependent information for which the acquisition request is made, to the storage (S214), reads out these pieces of dependent information from consecutive areas in the storage (S215), and transmits the pieces of dependent information to the front end as a response (S216). The dependent information acquisition request made by the front end in step S213 is a request made by a web browser that acquires an HTML file. The back end acquires this dependent information acquisition request, reads out corresponding information (dependent information) from the storage, and transmits the dependent information to the front end as a response.

### Application to Second Embodiment

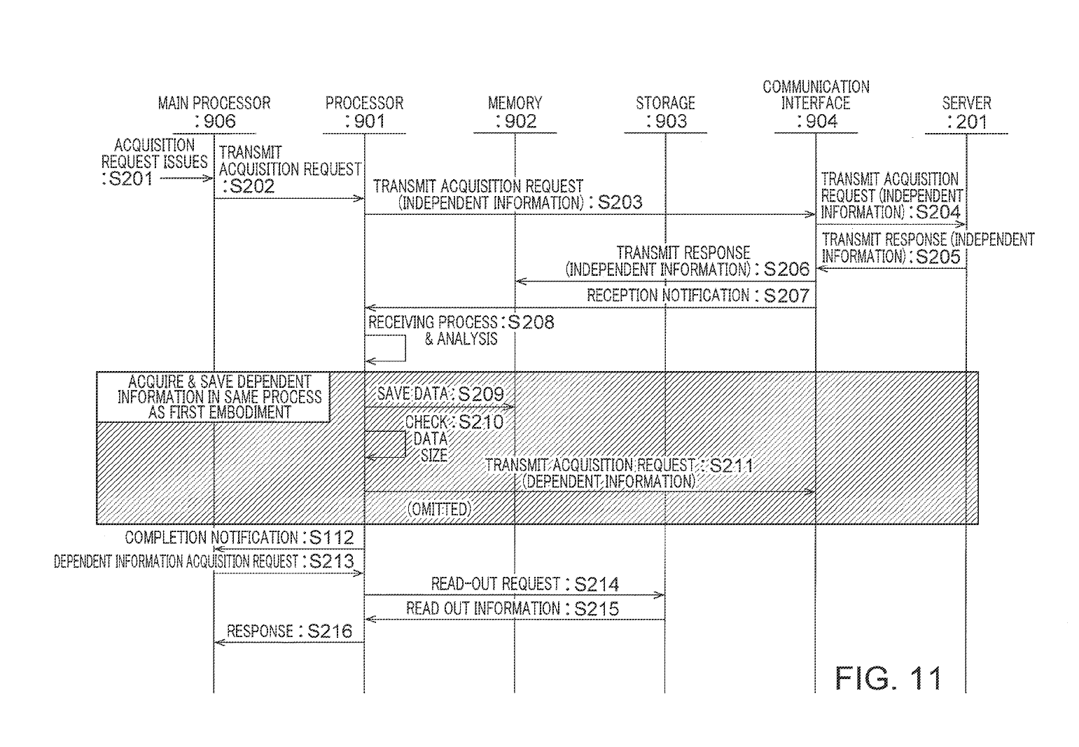

When the function in the present embodiment is applied to the second embodiment, the front end may run on the main processor 906, and the back end may run on the processor 901 in the module 900. FIG. 11 shows the sequence diagram of this case. This sequence is basically similar to that of FIG. 10 except that the front end runs on the main processor 906 and the back end runs on the processor 901 in the module 900, and thus the corresponding sequence elements are denoted by the same reference characters, and the description of FIG. 11 will not be made.

### Fourth Embodiment

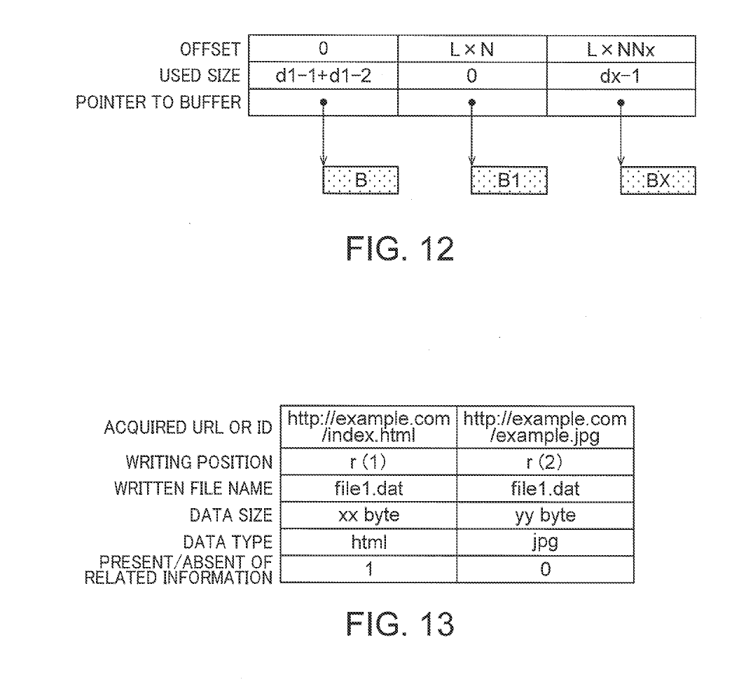

In the embodiment thus far, reserved areas are set in a buffer for a response as needed, and a reserved size is contained in management information on the buffer. In a buffer management scheme in the present embodiment, no reserved area is set in a buffer, and the term of reserved size is not also provided the management information on the buffer. The function in the present embodiment is applicable to any one of the first to third embodiments, and there will be described below the application to the third embodiment. A basic operation is similar to that in the embodiments thus far, and the description will be made below focusing on differences. FIG. 12 shows an example of buffer management information that is used in the following description. The term of reserved size is absent.

The processor 101 transmits the first acquisition request (equivalent to an acquisition request for independent information) to the server device 201. At this point, the processor 101 allocates a buffer having an Offset of zero (assumed to be a buffer B) as shown in a left column of the buffer management information in FIG. 12 (at this point, the used size thereof is zero). When receiving a response from the server device 201, the processor 101 acquires the value of Content-Length header contained in the response to calculate a size d1 of data to be received for the response. Note that this size d1 is equivalent to the size of a storage area required to store independent information that is acquired in response to the first acquisition request. The processor 101 newly allocates a buffer (assumed to be a buffer B1) to save a data item having a size of a remainder r that is obtained by dividing the size d1 by a buffer size (buffer length) L, as shown in the second column of the buffer management information in FIG. 12. At this point, the offset of the buffer B1 is L×N, where “N” is a quotient obtained by dividing the size d1 by the buffer size (buffer length) “L.” For example, when the size d1 is the buffer size L×4+r, the quotient is four, and thus the offset is L×4.

To acquire dependent information relating to a web page acquired with the first acquisition request (independent information) and write dependent information into the buffer, in the case of a piece of dependent information that is acquired next to the independent information, the writing is performed from an address that is shifted by r bytes from the head of the buffer B1 that is newly allocated in advance. Consequently, in the buffer B1, the tail of the first acquired web page is followed by the head of the piece of dependent information for which an acquisition request is made first subsequently to the web page in the buffer B1, except for the case where the tail of the acquired independent information accidentally becomes identical to the tail of the buffer B1. A position in the storage 103 to write the piece of dependent information that is acquired next to the independent information thereby becomes a position subsequent to the first acquired web page having a data length of L*N+r bytes.

As with the embodiments thus far, after the data item of a packet is written into the buffer, the used size of the management information on the buffer is updated (note that an unused size, which is obtained by subtracting the used size from the size of the buffer may be used instead of the used size.). When the used size becomes identical to the threshold value (buffer size), that is, when the unused size becomes zero, the data in the buffer is written out to the storage 103, and the buffer is released. Then, the offset is added by the buffer size L, and the released buffer is set as a new buffer (refer to FIG. 8(A)).

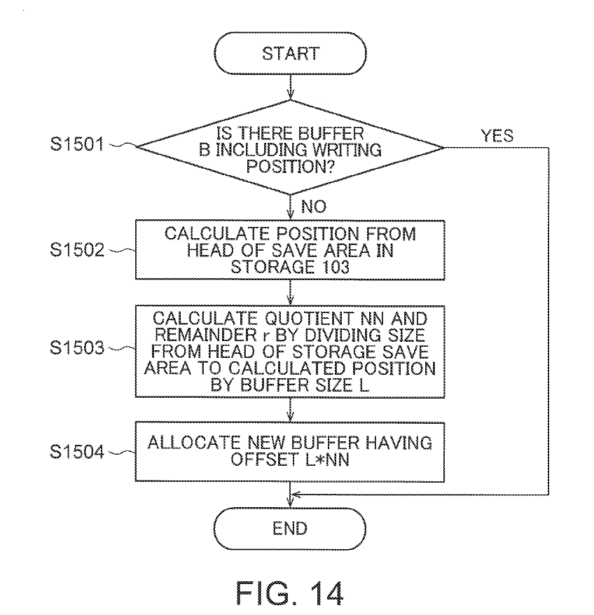

When transmitting an acquisition request or receiving a response, the processor 101 determines, as shown in the flow chart of FIG. 14, whether a buffer that includes a position to write data to be received in response to the acquisition request has been allocated (step S1501). Specifically, when an offset indicated by the management information on the buffer B is denoted by Offset(B) and the buffer size is denoted by L, it is determined whether there is any buffer that includes the writing position within a range between Offset(B) and Offset(B)+L. If there is no such a buffer, a start position to write data belonging to the response is calculated (step S1502).

In this case, the writing position is a position from the head of a save area in the storage. For example, in the case of the above-mentioned piece of dependent information that is acquired next to independent information, the writing position is a position next to L*N+r bytes. More generally, a quotient NNₓ and a remainder rₓ is calculated by dividing a size from the head of the save area in the storage up to the writing position by the buffer size L (step S1503), and a buffer on the buffer management information which contains an offset of Lₓ×NNₓ is newly allocated (step S1504) (refer to the right column in FIG. 12). Thereafter, the received response data is written from a position advanced by the remainder rₓ from the head of the buffer (i.e., a position in the buffer corresponding to a position from the head of save area in the storage). Assume that the size of a data item of a packet at this point is dx−1, the used size is dx−1 as shown in the right column in FIG. 12. FIG. 12 shows only three columns of pieces of buffer management information, a column is added as needed. Unlike the embodiments thus far, the buffer management information does not need to be managed for each response.

Note that the data to be written into the storage may be managed with storage management information as shown in FIG. 13. In this example, the storage management information is in a list form, but may be in the another form. The identifier (URL or ID) of information (independent information or dependent information), a writing position (a position from the head of the save area in the storage), a written file name, a data length, a data type, the presence/absence of related information (whether there is any information (dependent information) referred to from it itself) are contained. In the shown example, the acquired URL of the independent information is “http://example.com/index.html,” and data acquired with the URL is managed with a file named “file1.dat.” In addition, a URL (URL of the dependent information) referred to from the independent information is “http://example.com/example.jpg,” and the dependent information is managed by a file system with the same file named “file1.dat” as that of the independent information. In the storage, management information containing the size of data may be stored prior to each piece of information (independent information or dependent information) and the information (independent information or dependent information) may be stored following the management information.

As described above, according to the present embodiment, when data is written into a buffer, a writing position of the data from the head of a save area in a storage is calculated, and the data is written from a position in the buffer corresponding to the writing position, which eliminates the need of considering the length of a reserved area and the like as in the first embodiment, and thus it can be expected that the process is made to be light weight.

The data receiving device or the module as described above may also be realized using a general-purpose computer device as basic hardware. That is, each function block (or each section) in the data receiving device or the module can be realized by causing a processor mounted in the above general-purpose computer device to execute a program. In this case, data receiving device or the module may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

The term “storage” may generally encompass any device which can memorize data permanently by utilizing magnetic technology, optical technology or non-volatile memory such as an HDD, an optical disc or SSD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data receiving device comprising:
a communication circuit to receive first data and second data over a network;
a first storage in which data read or data write is performed;
a second storage in which data read or data write is performed by a fixed size block; and
a processor, wherein
the processor comprises a setter and a specifier, wherein the setter sets a buffer of a size of an integral multiple of the block size in the first storage, and the specifier specifies a size of the first data received at the communication circuit,
writes the first data received at the communication unit into an available area in a first buffer preset in the first storage,
sets a second buffer in the first storage and allocates an area in the second buffer, the area having a size of a remainder that a first value is divided by a size of the first buffer, the first value being a value subtracted from a size of the first data by a size of the available area in the first buffer before writing of the first data,
writes out data in the first buffer to the second storage and releases the first buffer when an amount of the data in the first buffer reaches a first predetermined value in writing of the first data into the first buffer, and
writes tail data of the first data, which has a size of the remainder, into the allocated area in the second buffer, writes the second data into an area starting from an address sequential to an end addresses of the allocated area in the second buffer, and writes out data in the second buffer to the second storage when an amount of the data in the second buffer reaches a second predetermined value in writing of the second data.

2. The data receiving device according to claim 1, wherein the first predetermined value is identical to a size of the first buffer, and the second predetermined value is identical to a size of the second buffer.

3. The data receiving device according to claim 1, wherein a speed of data read and data write in the first storage is higher than a speed of data read and data write in the second storage.

4. The data receiving device according to claim 1, wherein
the processor sets the second buffer in the second storage when a quotient of the first value divided by the size of the first buffer is greater than zero, and does not set the second buffer when the quotient is zero, and
writes the second data into an area starting from an address sequential to an end address of the area in which the first data is stored, when not setting the second buffer in the second storage.

5. The data receiving device according to claim 1, wherein an area immediately previous to the available area in the first buffer is an area in which data received before reception of the first data is stored, or an area allocated to store the data received before reception of the first data.

6. The data receiving device according to claim 1, wherein the first buffer is an available area largest among a plurality of available areas preset in the first storage, and the first data is written from a head of the first buffer.

7. The data receiving device according to claim 1, wherein in a case where writing of the second data is completed, when there is no other data to be received other than the first data and the second data, data in the second buffer is written out to the second storage even in a case where the amount of the data in the second buffer does not reach the second predetermined value.

8. The data receiving device according to claim 1, wherein
the communication circuit transmits a first acquisition request to a first device and transmits a second acquisition request different from the first acquisition request to the first device or a second device different from the first device, and
the first data is data transmitted from the first device in response to the first acquisition request and the second data is data transmitted from the first device or the second device in response to the second acquisition request.

9. The data receiving device according to claim 8, wherein
the first acquisition request and the second acquisition request are transmitted under HTTP, and
the processor specifies the size of the first data from a Content-Length header in an HTTP header contained in the first data.

10. The data receiving device according to claim 9, wherein
one or more first response packets are received one by one in response to the first acquisition request and the first data is dividedly contained in payload portions in the one or more first response packets, and
one or more second response packets are received one by one in response to the second acquisition request and the second data is dividedly contained in payload portions in the one or more second response packets.

11. The data receiving device according to claim 10, wherein the processor extracts the Content-Length header in the HTTP header from data contained in a head response packet of the first response packets.

12. The data receiving device according to claim 9, wherein the processor analyzes the first data to generate the second acquisition request.

13. The data receiving device according to claim 12, wherein the second acquisition request is a request to acquire data from a link destination referred to in the first data.

14. The data receiving device according to claim 8, wherein
the processor acquires the first acquisition request from an external processor and transmits the first acquisition request via the communication circuit, and
the data receiving device shifts to a low-power-consuming state after the first data and the second data are saved in the second storage or after the first data and the second data are output to the external processor.

15. The data receiving device according to claim 14, wherein after saving the first data and the second data in the second storage, the processor transmits a completion notification of the first acquisition request to the external processor.

16. The data receiving device according to claim 1, wherein the first data and the second data written into the second storage are managed in one same file.

17. A data receiving method by a computer, comprising:
receiving first data over a network;
specifying a size of the first data;
receiving the second data over a network;
writing the first data into an available area in a first buffer preset in the first storage, the first buffer having a size of an integral multiple of a fixed block size;
setting a second buffer in the first storage;
securing an area in the second buffer, the area having a size of a remainder that a first value is divided by a size of the first buffer, the first value being a value subtracted from a size of the first data by a size of the available area in the first buffer before writing of the first data;
detecting that an amount of the data in the first buffer reaches a first predetermined value in writing of the first data into the first buffer;
writing out data in the first buffer to a second storage in which data read or data write is performed by the fixed size block and releasing the first buffer;
writing tail data of the first data, which has a size of the remainder, into the allocated area in the second buffer;
writing the second data into an area starting from an address sequential to an end addresses of the allocated area in the second buffer;
writing out data in the second buffer to the second storage when an amount of the data in the second buffer reaches a second predetermined value in writing of the second data.
